(19) United States
(12) Patent Application Publication
(10) Pub. No.: US 2009/0139231 A1
(43) Pub. Date: Jun. 4, 2009

(54) Turbocompound engine drive

(76) Inventors: Frank Eberle, Mosbach (DE); Thomas Laufer, Ellhofen (DE)

Correspondence Address: KLAUS J. BACH & ASSOCIATES;PATENTS AND TRADEMARKS, 4407 TWIN OAKS DRIVE, MURRYSVILLE, PA, 15668, US

(21) Appl. No.: 12/317,281

(22) Filed: Dec. 19, 2008

Related U.S. Application Data
(63) Continuation-in-part of application No. PCT/EP2007/004367, filed on May 16, 2007.

(30) Foreign Application Priority Data
Jun. 20, 2006 (DE) 10 2006 028 235.3

(51) Int. Cl. F02G 3/00

(52) U.S. Cl. 60/624

(57) ABSTRACT

In a turbocompound engine drive including an engine with a crankshaft, an exhaust gas turbine operatively connected to the crankshaft via a reduction gear structure and a hydrodynamic clutch providing together for a power transmission path between the engine a freewheel is integrated into the power transmission path between the turbine and the crankshaft of the engine for disconnecting the turbine from the engine when the turbine speed is lower than the comparable engine speed to prevent the turbine from being driven by the engine.

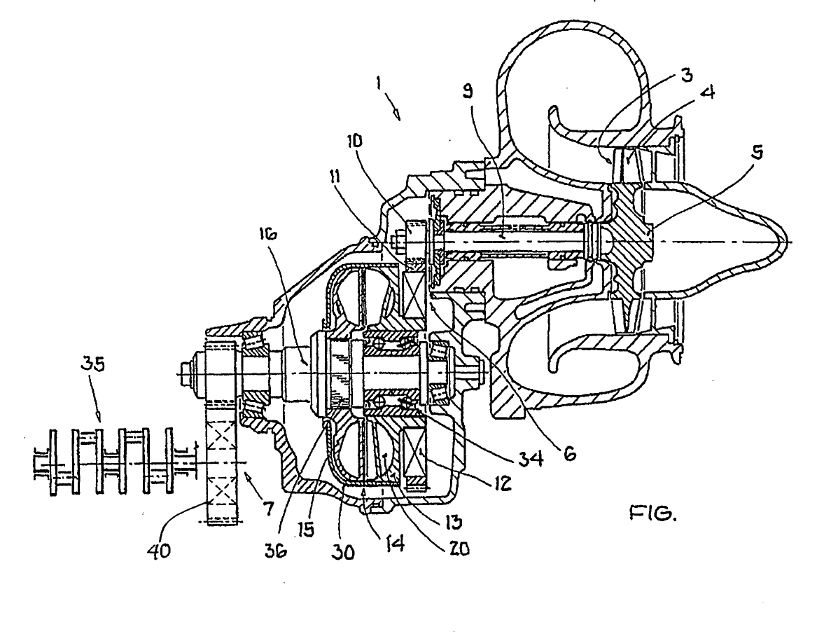

This is a Continuation-In-Part Application of pending International patent application PCT/EP2007/004367 filed May 16, 2008 and claiming the priority of German patent application 10 2006 028 235.3 filed Jun. 20, 2006.

### BACKGROUND OF THE INVENTION

The invention relates to a turbocompound engine drive including an engine with a crankshaft and an exhaust gas turbine connected to the crankshaft of the engine via a reduction gear and a hydrodynamic clutch.

A turbocompound engine drive is already known for example, from DE 103 19 748 A1. In this turbocompound engine drive, an exhaust gas power turbine is provided, which drives a crankshaft of the engine via a hydrodynamic clutch. The blades of the pump wheel and of the turbine wheel of this hydrodynamic clutch are inclined in relation to their longitudinal axis and are arranged with free play in relation to each other, wherein the blades of the primary wheel are inclined in the direction of rotation and the blades of the secondary wheel are inclined opposite to the direction of rotation.

A turbocompound engine drive with a hydrodynamic clutch is also known from DE 103 60 155 A1. The pump wheel of this hydrodynamic clutch can be coupled to a casing by means of a disk clutch so that the hydrodynamic clutch can also be operated as a retarder for braking a motor vehicle. As a consequence, the crankshaft in a braking mode, with this function used as a hydrodynamic retarder can be braked against the casing. Such a retarder assists the service brake of the commercial vehicle. In order to design the disk clutch small, or not to overload the disk clutch, despite the high braking loads, the hydrodynamic clutch can be drained to a predetermined filling level. A hydrodynamic clutch which is variable by the filling level is also described in WO 2005/040578 A1.

DE 102 04 066 A1 refers to a controllable hydrodynamic clutch of a turbocompound engine.

It is the object of the present invention to provide a turbocompound engine drive with a particularly high efficiency.

### SUMMARY OF THE INVENTION

In a turbocompound engine drive including an engine with a crankshaft, an exhaust gas turbine operatively connected to the crankshaft via a reduction gear structure and a hydrodynamic clutch providing together for a power transmission path between the engine a freewheel is integrated into the power transmission path between the turbine and the crankshaft of the engine for disconnecting the turbine from the engine when the turbine speed is lower than the comparable engine speed to prevent the turbine from being driven by the engine.

In the partial-load range of the internal combustion engine, the turbocompound engine drive would have a poorer efficiency compared with a drive train without a turbocompound engine drive. This would result in higher fuel consumption as a consequence since a power flow from the crankshaft to the exhaust gas power turbine would take place. There is a particularly high efficiency only in the full-load range of the internal combustion engine. By means of the freewheel component, it is possible in the partial-load range to interrupt the undesirable reversed power flow from the crankshaft to the exhaust gas power turbine. As a result, the efficiency of the internal combustion engine is increased.

In an especially advantageous embodiment, the freewheel is arranged in the region of a reduction gear between the exhaust gas power turbine and the hydrodynamic clutch.

Preferably, the reduction gear is a toothed-wheel gear since gears of this type have high freedom of maintenance for example in comparison with V-belts or toothed belts.

The freewheel in this case can be arranged in an especially advantageous way between the pump wheel gear, that is, the second gear and the pump wheel of the hydrodynamic clutch. In this way, the other gear of the reduction gear is not coupled during partial load operation. Furthermore, the speed on this second toothed wheel of the reduction gear is lower, which reduces the centrifugal forces which act on the freewheel. The gear wheel which is carried by the freewheel can especially be in the form of a gear ring.

In a further embodiment the freewheel may also be arranged in the region of an output shaft of the hydrodynamic clutch.

The invention will become more readily apparent from the following description of exemplary embodiments thereof on the basis of the accompanying drawing.

### BRIEF DESCRIPTION OF THE DRAWING

The sole FIGURE shows a turbocompound engine drive train.

### DESCRIPTION OF ADVANTAGEOUS EMBODIMENTS

A turbocompound engine drive train 1 presented in the FIGURE, is not shown in full detail, It includes also a driving engine, for example, a diesel engine with a crankshaft 35, a transmission and a driven shaft.

From an exhaust gas manifold of the engine, the exhaust gas flow is directed to a turbocharger, which is not shown, for engine charging and therefore for improving the overall efficiency of the drive train.

The exhaust gas of this diesel engine then is conducted to an exhaust gas power turbine 3. In the turbine, the exhaust gas is directed past blade 4 of an exhaust gas power turbine wheel 5 of the exhaust gas power turbine 3.

As a result of the exhaust gas flow, the exhaust gas power turbine wheel 5 rotates at a speed of up to 60000 RPM. The speed is reduced via two consecutive reduction gears 6, 7 to the speed range of a crankshaft 2 of the diesel engine, which on average is only about 2000 RPM. For this purpose, the exhaust gas power turbine wheel 5 is connected in rotationally fixed manner via an exhaust gas power turbine shaft 9 to a small helical-toothed first gear wheel 10 which meshes with a similarly helical-toothed large second gear ring 11. This large second gear ring 11 is connected in a rotationally fixed manner to an outer ring of a freewheel 12. An inner ring of this freewheel 12 on the other hand is connected in a rotationally fixed manner to a pump wheel 13 of a hydrodynamic clutch 14 so that, during full-load operation i.e. with power flow from the exhaust gas power turbine 3 to the crankshaft 35, the gear ring 11 supplies power to the engine through the hydrodynamic clutch 14. As a result, the hydrodynamic clutch 14 reduces rotational oscillations on the crankshaft 35.

The small first toothed wheel 10 together with the large second gear ring 11 forms the first of the two-stage reduction gear 6. Blades 20 are integrated into the pump wheel 13. These blades 20 point forwards with respect to blades of a turbine wheel 15. The turbine wheel 15 of the hydrodynamic clutch 14 is coaxially and rotatably arranged adjacent the pump wheel 13 so that it can be fluidically driven by the pump wheel 13. In this case, the pump wheel 13 and the turbine wheel 15 are arranged in a casing shell 30 which is rotatable in relation to the turbine wheel 15 and rotationally fixed in relation to the pump wheel 13. For said fluidic drive, oil is provided in the hydrodynamic clutch 14, which during full-load operation

transmits torque to the hydrodynamic clutch 14 and

cools and lubricates the hydrodynamic clutch 14.

The pump wheel 13 by means of rolling bearings 34 is rotatably arranged on an output shaft 16 of the hydrodynamic clutch 14. The turbine wheel 15 is mounted onto the output shaft 16 in a rotationally fixed manner by means of a splined shaft toothing 36.

The turbine wheel 15 transmits drive torque to the crankshaft 35 via the output shaft 16 and the second reduction gear 7. This second reduction gear 7 also steps down the speed and is also realized by means of a toothed gearwheel pairing.

If, for example in the partial-load range when the turbine speed is relatively low, torque would be transmitted from the crankshaft 35 to the turbine 3, then the freewheel 12 freely rotates so that the exhaust gas power turbine 3, the exhaust gas power turbine shaft 9, the first small toothed wheel 10 and the gear ring 11 are not coupled. Consequently, the friction losses are minimized.

So as not to impair the functioning of the freewheel by high centrifugal forces, the gear ring 11 can be constructed significantly thicker than it is shown in the drawing, so that the freewheel is arranged on a relatively small diameter of the pump wheel 13. The torque loading of the freewheel 12 decreases as its diameter increases, wherein, however, the reduction of the centrifugal forces play the greater role in this case.

In the same drawing, a further embodiment is shown. In this case, a freewheel 40, which is schematically shown by broken lines, is arranged in the region of the output shaft 16 so that the power flow from the second reduction gear 7 to the hydrodynamic clutch 14 can be interrupted.

Instead of a diesel engine, another internal combustion engine, especially an Otto engine, can also be provided.

The described embodiments are only exemplary developments. A combination of the described features for different embodiments is also possible. Further features of the device components which are associated with the invention, can be gathered from the arrangements of the device components which are shown in the drawings.

What is claimed is:

1. A turbocompound engine drive (1) including an engine with a crankshaft (35), an exhaust gas power turbine (3) operatively connected to the crankshaft (35) via a reduction gear structure (6, 7) and a hydrodynamic clutch (14) providing together for a power transmission path between the turbine (3) and the engine, and a freewheel (12) integrated in the power transmission path between the exhaust gas power turbine (3) and the crankshaft (35).

2. The turbocompound engine drive (1) as claimed in claim 1, wherein the reduction gear structure (6, 7) includes first and second reduction gears (6, 7) and the freewheel (12) is integrated in one of the reduction gears (6, 7).

3. The turbocompound as claimed in claim 2, wherein the reduction gears (6, 7) are arranged in first and second stages (6, 7), the hydrodynamic clutch (14) being disposed in the first reduction stage (6).

4. The turbocompound as claimed in claim 3, wherein the freewheel (12) is arranged radially between an outer gear ring (11), which is disposed in first stage (6) of the two-reduction gear stages (6, 7), and a pump wheel (13) of the hydrodynamic clutch (14).

5. The turbocompound (1) as claimed in claim 2, wherein the hydrodynamic clutch (14) transmits power to the crankshaft (35) via an output shaft (16) and the second reduction gear stage (7), and the freewheel (40) is arranged in the second reduction gear stage (7) so that the power flow from the second reduction gear (7) to the hydrodynamic clutch (14) can be interrupted.
